(19) United States
(12) Patent Application Publication
(10) Pub. No.: US 2014/0167373 A1
(43) Pub. Date: Jun. 19, 2014

(54) Rolling PVC cart for curbside ricycle bins

(71) Applicant: Alvaro Cesar Aguirre, Port Charlotte, FL (US)

(72) Inventor: Alvaro Cesar Aguirre, Port Charlotte, FL (US)

(73) Assignee: Alvaro C. Aguirre

(21) Appl. No.: 13/998,770

(22) Filed: Feb. 18, 2014

Related U.S. Application Data
(60) Provisional application No. 61/797,712, filed on Dec. 14, 2012.

(51) Int. Cl. B62B 1/10

(52) U.S. Cl. CPC B62B 1/10
USPC 280/29

(57) ABSTRACT

The main purpose of my Rolling Recycle Bin Dolly, or Cart, is to make easier the task of taking the household recycling items like paper, cardboard, glass, plastic containers, etc, out to the curb to be picked up. It allows the user to transport both bins in one single trip, with minimum effort as opposed to carrying them by hand. This also helps to avoid physical injuries caused by lifting heavy loads.

Another purpose of the cart is to keep the recycle bins together and out of the way, helping keep the garage, driveway or patio uncluttered.

Although this cart could be made of welded steel or aluminum pipes, PVC is the most commonly used material because it does not rust, does not need to be painted, and shows no significant deterioration over time, even being exposed to sunlight, cold, heat or rain.

Recycle bin carts have been around for several years. The traditional PVC carts use four vertical pipes, two in the front and two in the back, to connect the bottom tray to the top tray. The bins rest on these trays. This is a strong frame, but the two pipes in the front make it harder to put the bottom bin on its tray, specially the modern recycle bins which have large handles, thus forcing the cart to be extremely wide to allow the handles to go past these two vertical pipes. My new cart features an open, pipe-free front. This is achieved by setting back the two front pipes, so the bin handles do not need to go past such pipes, and the cart does not need to be too wide. It's also easier to place the bottom bin on its resting position on the tray. My cart also sets the bottom tray closer to the floor, and the top tray higher, which allows for a 12 inch gap between the bins, making filling them up easier.

### Materials Used

Pipes: PVC (Poly Vinyl Chloride) Schedule 40, pre-manufactured, usually ¾ inch. Fittings: PVC Schedule 40. “Tee” fittings used: 16 units. “Elbow” fittings used: 10 units. The pipes fit tightly into the fittings and are also glued to them with PVC solvent cement. Wheels: usually, solid molded plastic, 6 inch by 1⅜ inch. They are attached to the frame by two 5/16 inch by 3¼ inch steel screws and safety locknuts, either stainless or galvanized steel. The cart stands in an upright position, slightly tilted back to keep the recycle bins from falling forward. The two “Tee” fittings of the bottom tray are also the legs that touch the floor.

### BRIEF DESCRIPTION OF DRAWINGS

FIG. 1 represents an angled view of the cart, where TT is the Top Tray that supports the top recycle bin, and BT the Bottom Tray holding the bottom recycle bin. BT has two Tee fittings that touch the floor and serve as kgs to support the cart in its resting position.

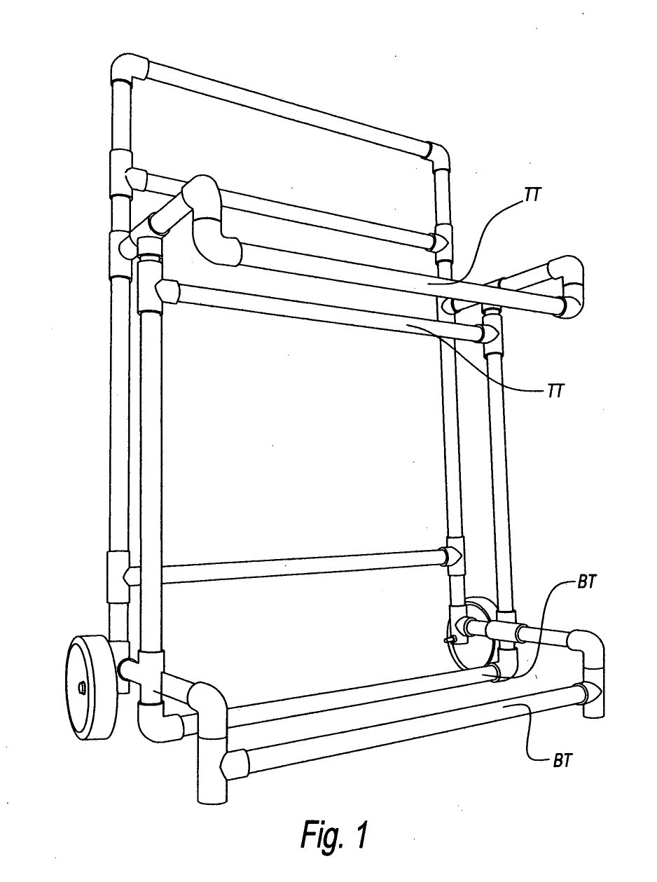

FIG. 2 represents a side view of the cart, left side, where the fittings E are 2-way 90-degree Elbows and the fittings T are 3-way Tees. These are the only type of fittings used in the cart. W are the plastic wheels, normally 6 by 13/8 inch, although other sizes or styles could be used. These wheels are attached to the frame by two 5/16 by 3¼ inch steel bolts and locknuts to prevent them from coming loose. A 5/16 inch washer is placed between the bolt head and the wheel. The top bar acts as a handle to maneuver the cart, and protrudes about 2 inches above the top recycle bin edge. The dotted line shows the position of the recycle bins Ron the cart.

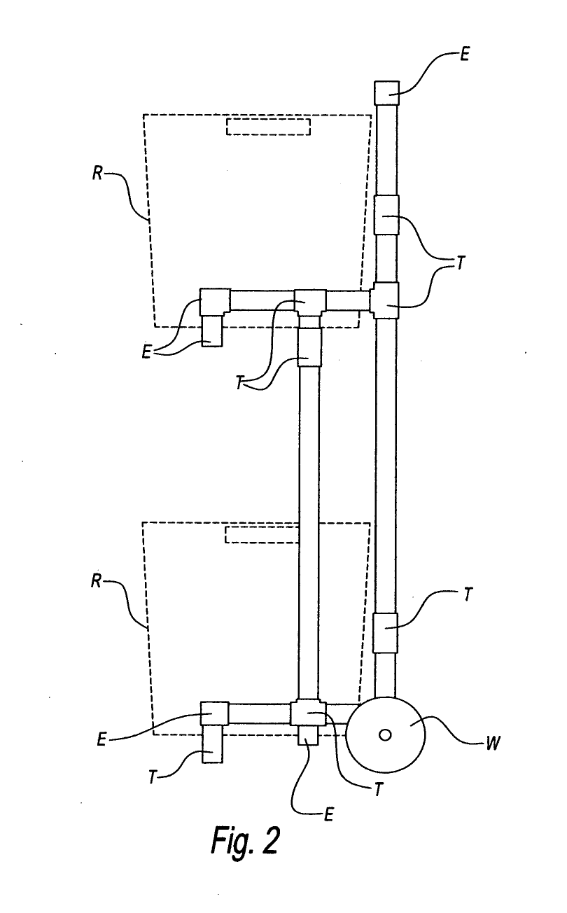

FIG. 3 represents a front view of the cart. As in the above figures, T are the Tee fittings, E are the Elbow fittings and W are the plastic wheels.

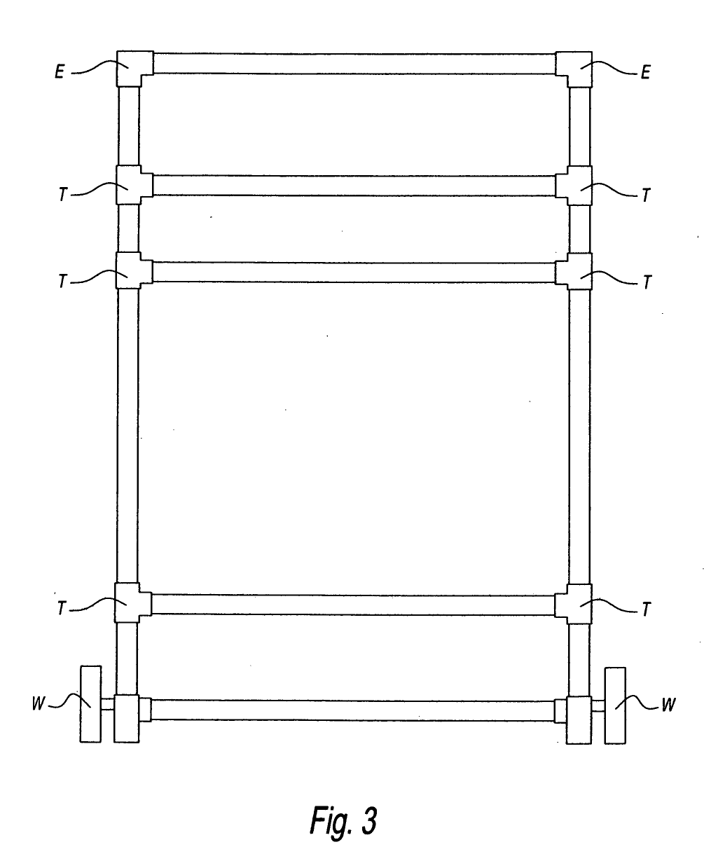

FIG. 4 represents another angled view of the cart, also showing the recycle bins in a dotted line. In this drawing, the Tee fitting placed right to the left of the wheel is a regular 3-way Tee fitting that has been converted into a 4-way “Cross” by drilling a hole through it with a special cutting tool. This allows the vertical pipe to pass through it, eliminating the need for a 4-way Cross fitting which cost is four times higher.

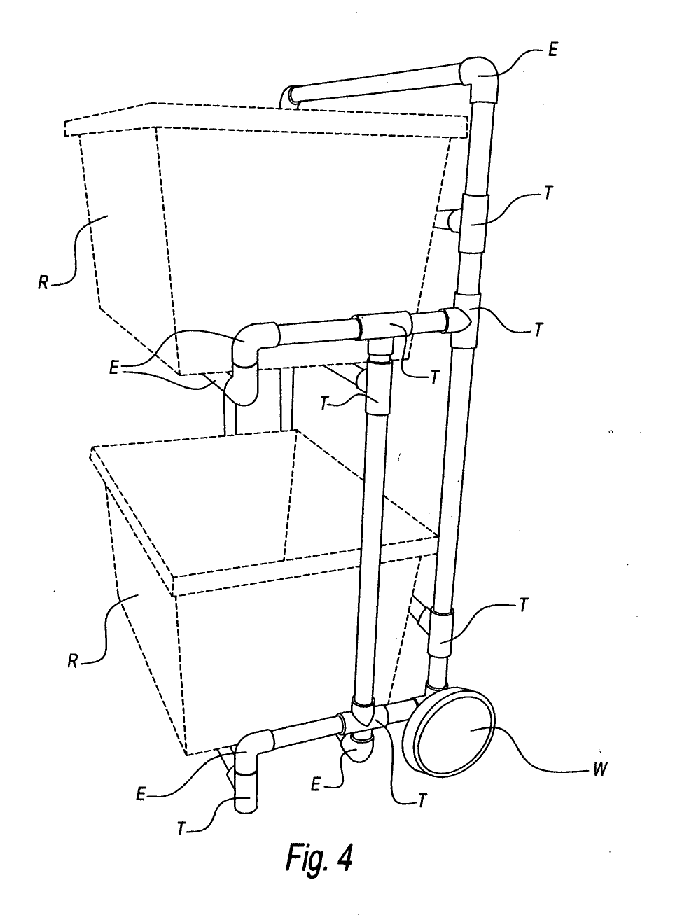

What I am claiming is:

1. A Rolling P.V.C. (Poly Vinyl Chloride) Curbside Recycle Bin Dolly.
